(19) United States
(12) Patent Application Publication
(10) Pub. No.: US 2013/0252219 A1
(43) Pub. Date: Sep. 26, 2013

(54) AUSCULTATION TRAINING APPARATUS AND METHOD

(71) Applicant: Paul Jacques Charles Lecat, Tallmadge, OH (US)

(72) Inventor: Paul Jacques Charles Lecat, Tallmadge, OH (US)

(21) Appl. No.: 13/848,920

(22) Filed: Mar. 22, 2013

Related U.S. Application Data
(60) Provisional application No. 61/614,001, filed on Mar. 22, 2012.

(51) Int. Cl. G09B 23/28

(52) U.S. Cl. CPC G09B 23/28
USPC 434/266

(57) ABSTRACT

An auscultation apparatus may include a sensor sheet having a flexible sheet with sensors, a processor having sound files, and an auscultation device, such as a stethoscope. The sensor sheet may be applied to a living body-like structure. When a sensor activator is positioned near one of the sensors, a sound may be transmitted from one of the sound files to provide the sound to an operator.

This patent claims priority from U.S. Ser. No. 61/614,001 titled AUSCULTATION TRAINING APPARATUS AND METHOD, filed on Mar. 22, 2012 which is incorporated herein by reference.

### BACKGROUND

A. Field of the Invention

This invention generally relates to apparatuses and processes for providing instruction, testing or grading of a person's knowledge, skill, discipline, or mental or physical ability, and demonstrating characteristics relating to an imitation of a noise made by the body.

B. Description of Related Art

U.S. Pat. No. 6,220,866 discloses an ELECTRONIC AUSCULTATION SYSTEM FOR PATIENT SIMULATOR for simulating sounds arising from human organs for use in an anatomical simulation device including a patient simulating mannequin torso, a plurality of electro-magnetic transmitters having antenna coils positioned in predetermined locations relative to said torso beneath the torso surface and each transmitter being connected to one or more computer sound cards which, upon activation, generate signals from prerecorded sound data which generates the appropriate sounds of human organs based on the transmitter location. The system utilizes a simulated stethoscope that includes a receiver and/or sensing triggering devices so that the stethoscope can determine particular areas on the torso to define the appropriate sound generated such that the system knows where the stethoscope is.

### SUMMARY

According to one embodiment of this invention, an auscultation apparatus may be used by an associated operator. The auscultation apparatus may comprise: a first living body-like structure; a sensor sheet comprising: a sheet portion that is physically flexible; and, a plurality of sensors mounted to and supported by the sheet portion; a processor that: comprises a plurality of sound files and is in electric communication with the plurality of sensors; and, an auscultation device comprising: a receiver, a sound supplying component and a sensor activator component. The auscultation apparatus may be operable by applying the sensor sheet to the first living body-like structure and positioning the sensor activator component near one of the plurality of sensors to cause the one of the plurality of sensors to communicate electrically with the processor to transmit a sound from one of the sound files to the receiver to communicate the sound to the sound supplying component to provide the sound to the associated operator.

According to another embodiment of this invention, an auscultation apparatus may be used with an associated living body-like structure by an associated operator. The auscultation apparatus may comprise: a sensor sheet comprising: a sheet portion that is physically flexible and applyable to the associated living body-like structure; and, a plurality of sensors mounted to and supported by the sheet portion; a processor that: comprises a plurality of sound files and is in electric communication with the plurality of sensors; and, an auscultation device comprising: a receiver, a sound supplying component and a sensor activator component. The auscultation apparatus may be operable by applying the sensor sheet to the associated living body-like structure and positioning the sensor activator component near one of the plurality of sensors to cause the one of the plurality of sensors to communicate electrically with the processor to transmit a sound from one of the sound files to the receiver to communicate the sound to the sound supplying component to provide the sound to the associated operator.

According to yet another embodiment of this invention, a method may comprise the steps of: (A) providing a first living body-like structure; (B) providing an auscultation apparatus comprising: (1) a sensor sheet comprising: a sheet portion that is physically flexible; and, a plurality of sensors mounted to and supported by the sheet portion; (2) a processor that: comprises a plurality of sound files and is in electric communication with the plurality of sensors; and, (3) an auscultation device comprising: a receiver, a sound supplying component and a sensor activator component; (C) applying the sensor sheet to the first living body-like structure; (D) equipping an operator with the auscultation device; and, (E) positioning the sensor activator component near one of the plurality of sensors to cause the one of the plurality of sensors to communicate electrically with the processor to transmit a sound from one of the sound files to the receiver to communicate the sound to the sound supplying component to provide the sound to the operator.

Benefits and advantages of this invention will become apparent to those skilled in the art to which it pertains upon reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a plan view of an exemplary embodiment of the invention.

FIG. 2 is a side view of a sensor sheet shown in top view in FIG. 1.

FIG. 3 is a perspective view of the sensor sheet being applied to a living body-like structure.

FIG. 4 is a perspective view of another embodiment of the invention, wherein a sensor sheet is positioned in a cavity of a living body-like structure that is a mannequin.

### DETAILED DESCRIPTION

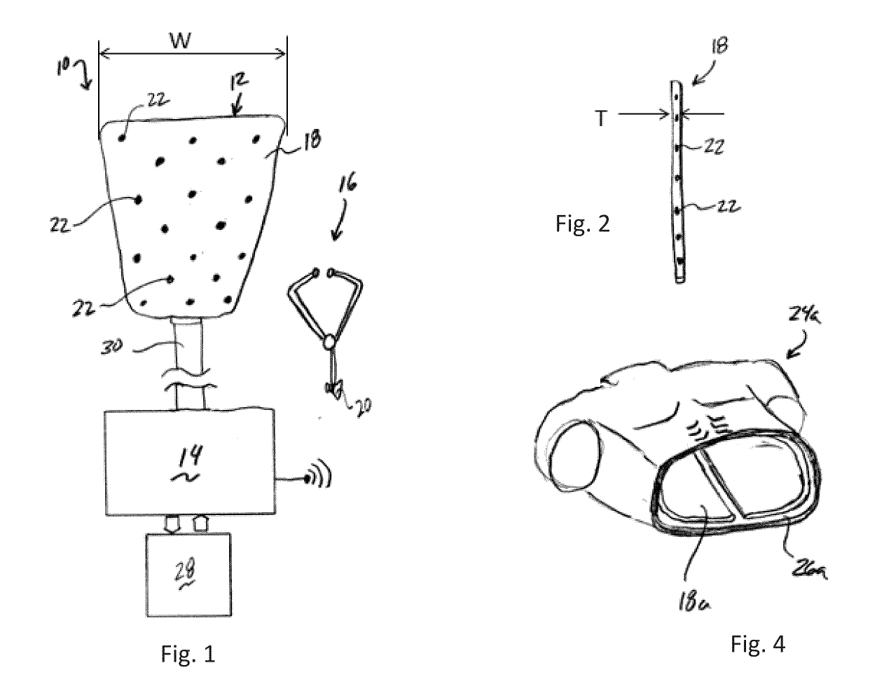

Referring now to the drawings wherein the showings are for purposes of illustrating embodiments of the invention only and not for purposes of limiting the same, and wherein like reference numerals are understood to refer to like components, FIG. 1 shows a plan view of an embodiment of the invention. An auscultation apparatus 10 may include a sensor sheet 12, a processor 14, and an auscultation device 16. The sensor sheet 12 may include a sheet portion 18 and a plurality of sensors 22 mounted to and supported by the sheet portion 18. It is noted that less than all of the sensors 18 are referenced in FIG. 1 to maintain the clarity of the drawing. The sensors 22 may be embedded in the sheet portion 18 or may be positioned at an exposed surface of the sheet portion 18.

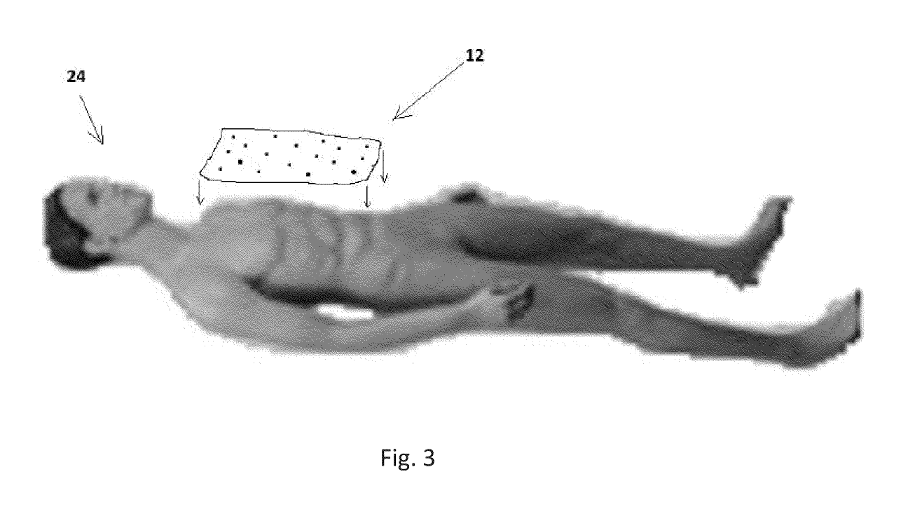

The sheet portion 18 may be a plastic, elastomeric/rubber, or any other material permitting physical flexibility. In operation, the sheet portion 18 may be mounted or applied to a living body-like structure. The physical flexibility of the sheet portion 18 may permit it to conform to a surface of the living body-like structure to which it is mounted or applied. By “living body-like structure” it is meant a structure that is, or is similar to, a living animal body or a living human body. In one embodiment the living body-like structure may be a humanoid mannequin, or a portion thereof. In another embodiment, the living body-like structure may be an actual deceased human body. In yet another embodiment, the living body-like structure may be an actual living human body. In still other embodiments, the living body-like structure may be any animal mannequin, deceased animal body, or actual living animal body. If the living body-like structure does not at least approximate an actual living body structure, it will be of limited value in training students. The sheet portion 18 can accommodate and conform around the shape of the living body-like structure. As shown in FIG. 3, the sheet portion 18 may be placed over the front upper torso of a living body-like structure 24. FIG. 4 shows an embodiment of the invention in which a sheet portion 18a extends around an inner cavity 26a of a living body-like structure 24a that is a portion of a mannequin. FIG. 2 shows that the sheet portion 18 may be relatively thin to enhance conformance with the mating surface on the living body-like structure. The sheet portion 18 shown in FIGS. 1 and 2 has a maximum width W and a maximum thickness T. In one embodiment, the ratio W/T is at least 5.0. In another embodiment, the ratio W/T is at least 10.0. In another embodiment, shown, the ratio W/T is at least 15.0. It is noted that the perimeter of the sheet portion 18 can define any desired shape.

The sensor sheet 12 may be connected to the living body-like structure (24 or 24a) in one or more different ways. Releasable adhesive may be applied to one side of the sensor sheet 12, for example. The adhesive can have binding strength sufficient to keep the sensor sheet 12 in place during use, but also permit removing the sensor sheet 12 so that the sensor sheet 12 may be used with more than one living body-like structure. Hook and loop fasteners can also be used with embodiments of the invention. Alternatively, an embodiment of the invention could be permanently attached to a living body-like structure, such as to a mannequin.

Each of the sensors 22 may be in electric communication with the processor 14. A wire harness 30 is shown connecting the processor 14 and the sensors 22 for electric communication in the exemplary embodiment. The processor 14 of the exemplary embodiment of the invention may be a controller as referenced at 120 in U.S. Pub. No. 2009/0117527 (“the '527 publication”), which is hereby incorporated by reference in its entirety. The exemplary embodiment 10 can function similarly to the system disclosed in the '527 publication. For example, a user such as a medical trainee, can place at least one sound supplying component, such as two ear-pieces, of the auscultation device 16 near or in his/her ears and place a sensor activator component, such as bell 20 of the auscultation device 16 against the living body-like structure. The one or more sensors 22 nearest the sensor activator component 20 will communicate this proximity to the processor 14. In response to a signal from one or more of the sensors 22, the processor 14 can select a sound file from a database 28.

Embodiments of the invention can incorporate databases having any appropriate data structure such as, without limitation, lists, hash tables, or hierarchical, relational, or network models. In some embodiments the database can include a group of sound files stored together on, for instance, a CD-ROM or flash memory. The database may be stored on any appropriate machine memory means including, without limitations, volatile or nonvolatile memories, EPROMs, EEPROMs, magnetic media such as tapes or hard drives, optical media such as CD-ROMs, and the like or any combination thereof.

The processor 14 can transmit a particular sound file to a receiver in the auscultation device which communicates the corresponding sound to the sound supplying component so that the operator can hear the sound. In one embodiment, the processor 14 transmits the sound file wirelessly to the receiver in the auscultation device 16. The auscultation device 16 of the exemplary embodiment may be a stethoscope as set forth in the '527 publication. In one embodiment, a sound generating device in the bell of the stethoscope can direct a sound wave against a diaphragm mounted on the bell. The diaphragm will then vibrate and the user will hear the sound. It is noted that other methods of communicating sound to the user may be applied in other embodiments of the invention.

Various approaches to wireless communication may be applied in embodiments of the invention. For example, radio or infrared protocols may be applied. Other protocols include, by way of example and not limitation, WiFi, Bluetooth® (Bluetooth is a registered certification mark of Bluetooth Sig Inc., Bellevue, Wash.), and ZigBee® (ZigBee is a registered trademark of ZigBee Alliance Corp., San Ramon, Calif.). It is noted that embodiments of the invention can include hardwired connections between the processor 14 and the auscultation device 16. Some such connections include, without limitation, serial bus, parallel bus, SCSI, I2C (inter-integrated circuit), SPI (serial peripheral interface), and the like or any combination thereof.

Sensors 22 may be positioned proximate to the heart region, the lung region, and any of a variety of visceral or thoracic regions. The sensors 22 may be selected to sense any one of a variety of conditions. For example, the sensors 22 may be engaged (or turned on) by the application of physical contact. Such physical conduct may, for example, create a pressure sensed by pressure sensors. Such sensors could be applied in the operating environment shown in FIG. 3, for example. Alternatively, the sensors 22 may be engaged (or turned on) by the application of a magnetic field. Such sensors could be applied in the operating environment shown in FIG. 4, in which the stethoscope would be positioned along an outer surface of the mannequin 24a and not within the cavity 26a. Other approaches to proximity detection may be applied, such as RFID chips, bar codes, binary magnet codes, or UV/IR light.

The living body-like structure 24, when a mannequin, may already incorporate an auscultation system; embodiments of the invention may be applied to render outdated mannequins useful again. Embodiments of the invention can also be applied to enhance the capabilities of mannequins currently in use. For example, embodiments of the invention can provide improved audio transmissions and also deliver additional sounds.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof Further, the “invention” as that term is used in this document is what is claimed in the claims of this document. The right to claim elements and/or sub-combinations that are disclosed herein as other inventions in other patent documents is hereby unconditionally reserved.

Having thus described the invention, it is now claimed:

I/we claim:

1. An auscultation apparatus for use by an associated operator, the auscultation apparatus comprising:
a first living body-like structure;
a sensor sheet comprising: a sheet portion that is physically flexible; and, a plurality of sensors mounted to and supported by the sheet portion;
a processor that: comprises a plurality of sound files and is in electric communication with the plurality of sensors;
an auscultation device comprising: a receiver, a sound supplying component and a sensor activator component; and,
wherein the auscultation apparatus is operable by applying the sensor sheet to the first living body-like structure and positioning the sensor activator component near one of the plurality of sensors to cause the one of the plurality of sensors to communicate electrically with the processor to transmit a sound from one of the sound files to the receiver to communicate the sound to the sound supplying component to provide the sound to the associated operator.

2. The auscultation apparatus of claim 1 wherein:
the first living body-like structure is an actual living human body.

3. The auscultation apparatus of claim 1 wherein:
the first living body-like structure is at least a portion of a humanoid mannequin.

4. The auscultation apparatus of claim 1 wherein:
the first living body-like structure is at least a portion of a humanoid mannequin and has an inner cavity; and,
the auscultation apparatus is operable by applying the sensor sheet to the first living body-like structure within the cavity.

5. The auscultation apparatus of claim 1 wherein:
the auscultation apparatus further comprises: one of: a hook and loop fastener; and, a releasable adhesive;
the auscultation apparatus is operable by applying the sensor sheet to the first living body-like structure using the one of a hook and loop fastener and a releasable adhesive; and,
the auscultation apparatus is operable by removing the sensor sheet from the first living body-like structure using the one of a hook and loop fastener and a releasable adhesive.

6. The auscultation apparatus of claim 5 wherein:
the auscultation apparatus further comprises a second living body-like structure; and,
the auscultation apparatus is operable by applying the sensor sheet to the second living body-like structure using the one of a hook and loop fastener and a releasable adhesive.

7. The auscultation apparatus of claim 1 wherein:
the sheet portion has a maximum width to maximum thickness ratio W/T that is at least 5.0.

8. The auscultation apparatus of claim 1 wherein:
the auscultation device is a stethoscope;
the sound supplying component comprises at least one ear-piece; and,
the sensor activator component comprises a bell.

9. An auscultation apparatus for use with an associated living body-like structure by an associated operator, the auscultation apparatus comprising:
a sensor sheet comprising: a sheet portion that is physically flexible and applyable to the associated living body-like structure; and, a plurality of sensors mounted to and supported by the sheet portion;
a processor that: comprises a plurality of sound files and is in electric communication with the plurality of sensors;
an auscultation device comprising: a receiver, a sound supplying component and a sensor activator component; and,
wherein the auscultation apparatus is operable by applying the sensor sheet to the associated living body-like structure and positioning the sensor activator component near one of the plurality of sensors to cause the one of the plurality of sensors to communicate electrically with the processor to transmit a sound from one of the sound files to the receiver to communicate the sound to the sound supplying component to provide the sound to the associated operator.

10. The auscultation apparatus of claim 9 wherein:
the sheet portion has a maximum width to maximum thickness ratio W/T that is at least 5.0.

11. The auscultation apparatus of claim 9 wherein:
the auscultation apparatus further comprises: one of: a hook and loop fastener; and, a releasable adhesive;
the auscultation apparatus is operable by applying the sensor sheet to the associated living body-like structure using the one of a hook and loop fastener and a releasable adhesive; and,
the auscultation apparatus is operable by removing the sensor sheet from the associated living body-like structure using the one of a hook and loop fastener and a releasable adhesive.

12. The auscultation apparatus of claim 9 wherein:
the auscultation device is a stethoscope;
the sound supplying component comprises at least one ear-piece; and,
the sensor activator component comprises a bell.

13. A method comprising the steps of:
(A) providing a first living body-like structure;
(B) providing an auscultation apparatus comprising: (1) a sensor sheet comprising: a sheet portion that is physically flexible; and, a plurality of sensors mounted to and supported by the sheet portion; (2) a processor that: comprises a plurality of sound files and is in electric communication with the plurality of sensors; and, (3) an auscultation device comprising: a receiver, a sound supplying component and a sensor activator component;
(C) applying the sensor sheet to the first living body-like structure;
(D) equipping an operator with the auscultation device; and,
(E) positioning the sensor activator component near one of the plurality of sensors to cause the one of the plurality of sensors to communicate electrically with the processor to transmit a sound from one of the sound files to the receiver to communicate the sound to the sound supplying component to provide the sound to the operator.

14. The method of claim 13 wherein:
step (A) comprises the step of: providing the first living body-like structure to be an actual living human body.

15. The method of claim 13 wherein:
step (A) comprises the step of: providing the first living body-like structure to be at least a portion of a humanoid mannequin.

16. The method of claim 13 wherein:
step (A) comprises the step of: providing the first living body-like structure to be at least a portion of a humanoid mannequin having an inner cavity; and,
step (C) comprises the step of: applying the sensor sheet to the at least a portion of a humanoid mannequin within the inner cavity.

17. The method of claim 13 further comprising the steps of:
providing a second living body-like structure;
removing the sensor sheet from the first living body-like structure;
applying the sensor sheet to the second living body-like structure; and,
positioning the sensor activator component near one of the plurality of sensors to cause the one of the plurality of sensors to communicate electrically with the processor to transmit a sound from one of the sound files to the receiver to communicate the sound to the sound supplying component to provide the sound to the operator.

18. The method of claim 17 wherein:
the method further comprises the step of: providing one of: a hook and loop fastener; and, a releasable adhesive;
step (C) comprises the step of: applying the sensor sheet to the first living body-like structure using the one of: a hook and loop fastener; and, a releasable adhesive.
the step of removing the sensor sheet from the first living body-like structure comprises the step of: removing the sensor sheet from the first living body-like structure using the one of: a hook and loop fastener; and, a releasable adhesive; and,
the step of applying the sensor sheet to the second living body-like structure comprises the step of: applying the sensor sheet to the second living body-like structure using the one of: a hook and loop fastener; and, a releasable adhesive.

19. The method of claim 13 wherein:
the method further comprises the step of: providing one of: a hook and loop fastener; and, a releasable adhesive; and,
step (C) comprises the step of: applying the sensor sheet to the first living body-like structure using the one of: a hook and loop fastener; and, a releasable adhesive.

20. The method of claim 13 wherein the method further comprises the step of:
positioning the sensor activator component near another of the plurality of sensors to cause the another of the plurality of sensors to communicate electrically with the processor to transmit a sound from another of the sound files to the receiver to communicate the sound to the sound supplying component to provide the sound to the operator.
